(19) United States
(12) Patent Application Publication
(10) Pub. No.: US 2007/0254510 A1
(43) Pub. Date: Nov. 1, 2007

(54) Magnetically Retained Electrical Connector

(76) Inventor: Henry C. DeBey, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/740,106

(22) Filed: Apr. 25, 2007

Related U.S. Application Data
(60) Provisional application No. 60/745,805, filed on Apr. 27, 2006.

(51) Int. Cl. H01R 29/00

(52) U.S. Cl. 439/188

(57) ABSTRACT

A signal carrying plug and a signal carrying receptacle form a magnetic signal carrying connector are provided wherein electrical terminals of the source and electrical contacts of the load are held against one another by at least one magnet affixed adjacent the source terminals confronting and attracted to magnetically interactive object affixed adjacent the load contacts, and wherein the at least one magnet is disposed within a recess to protect against projection of unwanted magnetic fields and to mate with a complementary structure to provide positive alignment and registration of the terminals and contacts. The force of the magnet is sufficient to hold the load contacts in place for operation but insufficient to provoke damage to the connector plug or attached receptacle and any attached structures, such as cabling, if the connector is pulled apart. the magnets serve as signal carrying terminals.

### CROSS-REFERENCES TO RELATED APPLICATIONS

The present application claims benefit under 35 USC 119(e) of U.S. provisional Application No. 60/745,805, filed on Apr. 27, 2006, entitled “Magnetically Retained Electrical Connector,” the content of which is incorporated herein by reference in its entirety.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

This invention relates to electrical connectors, particularly audio headset connectors with retention means and electrical connection means typically used for audio headset connectors.

A typical mechanism for electrically connecting headphones to audio devices is accomplished through the use of a multi-conductor cable with a small phone plug on the end that inserts into a mating receptacle or phone jack. This arrangement suffers several problems.

1. As the contacts inside the receptacle are cycled numerous times, they can become worn and less flexible resulting in poor connections or no connections at all.

2. Because the plug is held in the receptacle through friction, repeated cycling of the plug into and out of the receptacle causes wear thereby reducing the retention force exerted by friction.

3. If the cable attached to the plug is pulled in a direction that is not collinear with the longitudinal axis of the plug such that excessive strain is placed on the cable, the non-collinear strain can damage the cable, the plug and the receptacle. The electrical conductors of the cable can be broken or become intermittent. Thus, the headphones will not work consistently. The plug can be damaged as it is bent such that when it is again inserted into a receptacle, its various conductive elements might not adequately contact counterpart elements in the receptacle. The tip of the plug is sometimes broken off and may remain in the receptacle such that it impedes the insertion of another plug. The broken tip may also cause short circuits amongst the conductive elements inside the receptacle.

What is needed is a connector that is not subject to the above-listed problems.

Magnetically held connectors are known for certain applications, such as power. A magnetic plug is used in a power supply connector for some models of personal computers, wherein a magnetic ring surrounds a set of at least four spring-loaded nonmagnetic electrical terminals on the power-receiving unit. Examples are found in certain current models of Apple laptop computers. A patent on power connection owned by Apple is U.S. Pat. No. 5,455,467, which involves inductive power coupling.

Other known magnetic electrical connectors are described in the patent literature including U.S. Pat. No. 2,903,667 for a light bulb, and U.S. Pat. No. 6,039,591 for a locking electrical connector.

### BRIEF SUMMARY OF THE INVENTION

According to the invention, a signal carrying plug and a signal carrying receptacle form a magnetic signal carrying connector are provided wherein electrical terminals of the source and electrical contacts of the load are held against one another by at least one magnet affixed adjacent the source terminals confronting and attracted to magnetically interactive object affixed adjacent the load contacts, and wherein the at least one magnet is disposed within a recess to protect against projection of unwanted magnetic fields and to mate with a complementary structure to provide positive alignment and registration of the terminals and contacts. The force of the magnet is sufficient to hold the load contacts in place for operation but insufficient to provoke damage to the connector plug or attached receptacle and any attached structures, such as cabling, if the connector is pulled apart. the magnets serve as signal carrying terminals.

In a specific embodiment, the magnetically attractive structure is a ferrous plate. In another specific embodiment, the magnetically interactive structure of the plug is a magnet of attractive polarity to the at least one magnet of the complementary receptacle. In a further specific embodiment, a plurality of magnets are provided of both the load and on the source, and the magnets are polarized to both attract and provide reliable electrical registration of the connector. Other embodiments include adapters and the like specifically targeted for applications in armrests of aircraft.

One of the clear advantages of a connector according to the invention is that it supplants or replaces friction forces and locking mechanisms with forces generated by magnetic fields allowing breakaway detachment without damage to structures.

These and other advantages will be evident to those of skill in the art upon reference to the following detailed description and accompanying drawings.

### BRIEF DESCRIPTION OF THE DRAWINGS

FIG. 1 is an illustration of a first plug and receptacle combination for an earphone.

FIG. 2 is an illustration of a second plug for an earphone receptacle of the invention.

FIG. 3 is an illustration of a third receptacle combination for receiving a plug for an earphone.

FIG. 4 is a top view of a receptacle according to the invention.

FIG. 5 is an illustration of an adapter with a magnetic plug and a phone receptacle.

FIG. 6 is an illustration of first adapter with a phone plug and a magnetic receptacle.

FIG. 7 is an illustration of second adapter with a phone plug and a magnetic receptacle.

FIG. 8 is an illustration of an air rest as might be employed in an airliner with a magnetic receptacle according to the invention.

### DETAILED DESCRIPTION OF THE INVENTION

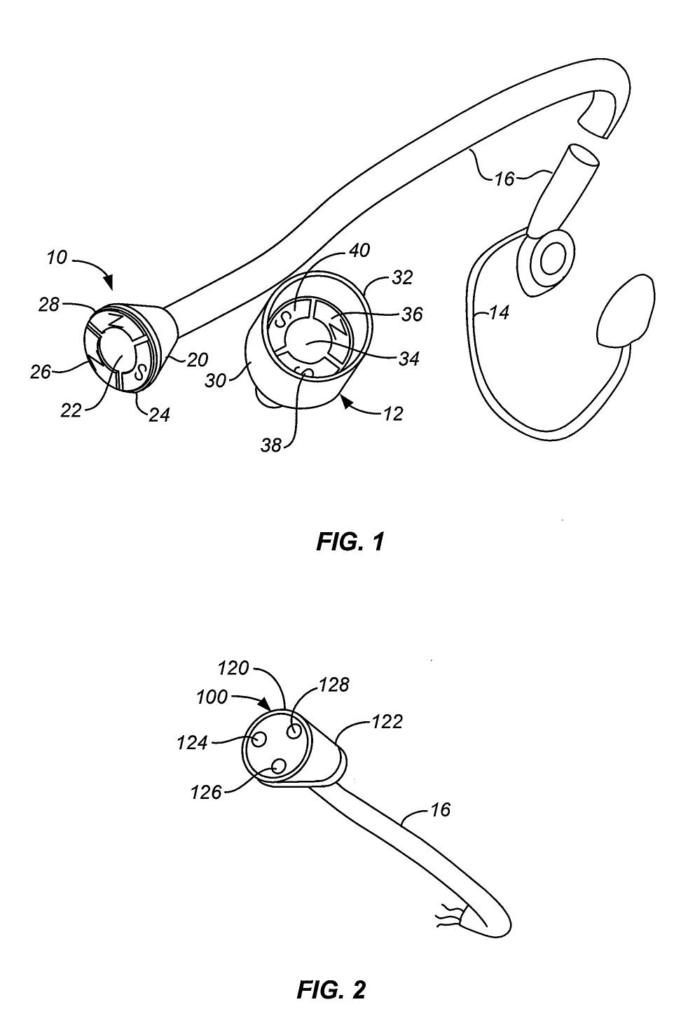

FIG. 1 is an illustration of a first plug 10 and receptacle 12 combination according to the invention for an earphone 14. The earphone could be an ear bud as shown or a headset, connected by a cord 16 to the plug 10. The plug 10 includes a rigid housing 20 with a contact surface 22 having conductive terminals 24, 26, 28 arranged along a circumference. The conductive terminals are for carrying audio level electrical signals to the earphone 14, typically two stereo signals and a common serving as a ground. The terminal 24 is selected to be a permanent magnet having an exposed south polarity face, and the terminals 26 and 28 are arranged on either side of terminal 24 and each have a north polarity face. The plug 10 mates with the receptacle 12, and the receptacle 12 includes a rigid housing 30 preferably with a collar 32 forming a recess for a contact surface 34 having conductive terminals 36, 38, 40 arranged along a circumference.

The conductive terminals are for audio level electrical signals from a remote audio amplifier (not shown) to the earphone 14 through the terminals, typically two stereo signals and a common serving as a ground. The terminal 36 is selected to be a permanent magnet having an exposed north polarity face, and the terminals 38 and 40 are arranged on either side of terminal 36 and each have a north polarity face. The terminals 24 and 36 mate and attract one another. Similarly the terminals 26 and 38 mate, and the terminals 28 and 40 mate, all attractive to one another with sufficient force to hold them in reliable electrical contact but with less force than would cause damage to the cord 16 if the plug and receptacle were pulled apart, either intentionally or accidentally. Three terminals 36, 38 and 40 serve as an inherently stable contact platform. Where more than three terminals are needed, it is prudent to provide a mechanism to assure positive contact with all terminals. While this is not necessary for a three-terminal connector, such a positive contact mechanism can also be employed. A suitable positive contact mechanism is a spring-loaded base for each contact in the housing 30. Springs add longitudinal flexibility. An alternative is a magnet made of rubberized magnetic material. These optional features apply to all terminal configurations hereinafter described. The collar 32 serves to keep the plug and the receptacle axially aligned with one another, but the magnetic terminals inherently orient with one another due to magnetic forces to align with the correct mating terminal.

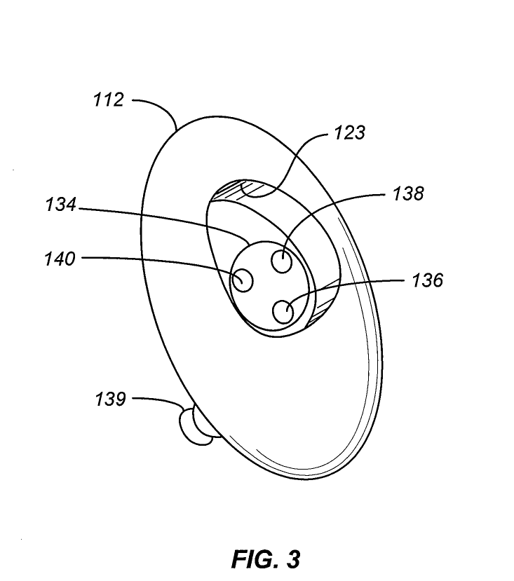

Referring to FIG. 2, a plug 100 is illustrated. In this embodiment, the electrical contacts 124, 126, 128 are preferably of ferrous material, i.e., non-magnetic but magnetically attractable. Hence, the contacts are not of gold, silver, copper or brass per se but include steel or an iron alloy, possibly having an anticorrosion coating. The connecter housing 120 is keyed for example with a tab 122 or a bevel selected to mate with a corresponding eccentric recess 123 of a receptacle 112 (FIG. 3). Thus the contacts 124, 126, 128 are aligned mechanically with the terminals 136, 138, 140. The terminals 136, 138, 140 are preferably all magnetic, although one magnet may be sufficient, and such a magnet need not be a normally electrically conductive terminal, so long as it serves to bring terminals in reliable electrical coupling with mating contacts. For example, in FIG. 3, the face 134 may be a fixed magnet, and the terminals 136, 138, 140 may be conventional gold contact terminals, optionally spring loaded, as described above. The advantage of non-magnetic contacts of FIG. 2 is the assurance that magnets will not interfere with magnetically sensitive devices, such as pacemakers, credit cards and other ferrous-containing objects. The advantage of non-ferrous materials in general is that they can be made to be oxidation and corrosion resistant.

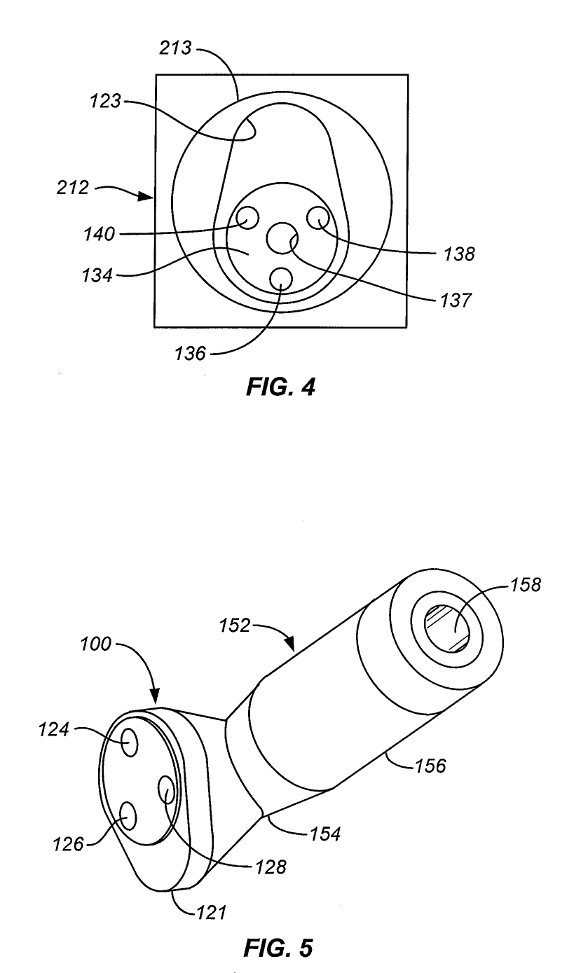

The magnets and terminals of FIG. 3 are conveniently within the protective recess 123 so that they are maintained at a safe distance from magnetically sensitive objects. The receptacle 112 is a structure particularly suited for mounting on an armrest 150 of an aircraft (FIG. 8). This structure is a convenient add-on to an existing receptacle in an aircraft armrest (FIG. 8), as it includes a conventional stereo phone plug 139 on its underside that plugs into a conventional chassis mount phone receptacle, as illustrated in FIG. 8. Alternatively, a magnetic receptacle 212 (FIG. 4) can be built into an aircraft armrest to receive complementary plugs of the type shown in FIG. 2. The recess 123 may be surrounded by a raised flange that mates with an existing opening in the armrest. In addition to the magnetic terminals 136, 138, 140, the center of the mounting face 134 may be provisioned with a conventional phone receptacle 137 also connected to the terminals so that the receptacle 212 is backwards-compatible with conventional and user-supplied headsets (not shown).

FIG. 5 illustrates another design of an adapter 152 constructed in accordance with the invention. At one end is a magnetic plug 100 with non-magnetic contacts and an eccentric key 121, as in FIG. 2. The adapter 152 has an elbow 154 and a neck 156, and at the opposing end a conventional stereo receptacle 158 connected to the terminals 124, 126, 128 for receiving a conventional phone plug (not shown).

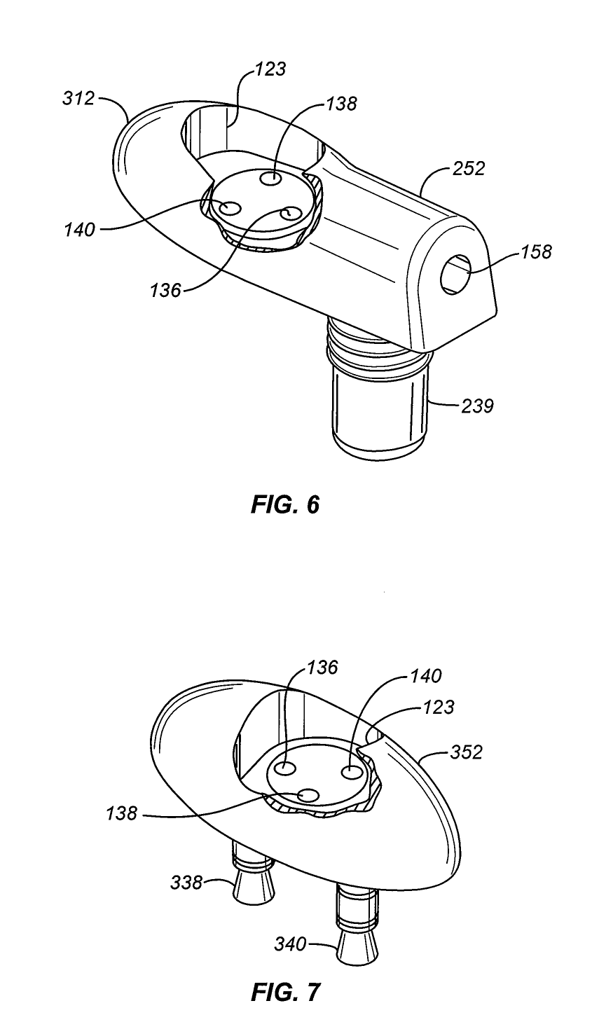

FIG. 6 illustrates a still further embodiment of an adapter 252 wherein the body is designed for near-flush mounting on a plurality of surfaces, such as an armrest, and has on one side a magnetic receptacle having the same features as in FIG. 3 with an eccentric recess 123 forming a keyway, and at the other side a conventional phone receptacle as in FIG. 5. An audio plug 239 of any design or other connection known in the art is connected internally to the magnetic receptacle 312 and the conventional receptacle 158.

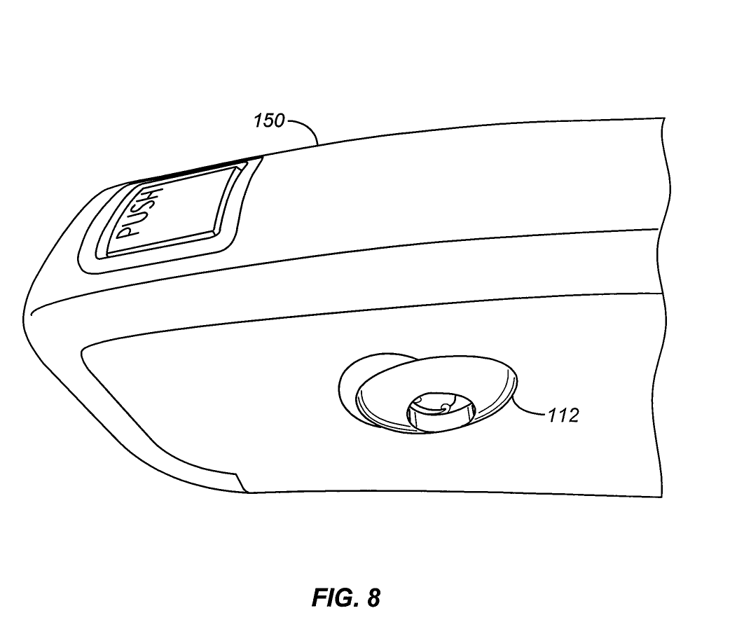

FIG. 7 illustrates yet another design of an adapter 352 constructed in accordance with the invention wherein the body is designed for near-flush mounting on a surfaces, such as an armrest and with the same features as in FIG. 3 with an eccentric recess 123 forming a keyway. The adapter includes two conventional phone plugs 338, 340 matching the type of phone receptacles found in selected aircraft armrests. It is also of a form factor designed for near flush mounting on an armrest.

The adapters 112, 252 and 352 are of a type intended to be convenient retrofits for existing conventional armrests, whereas the receptacle 212 of FIG. 4 is of a type intended to be a versatile permanent replacement for aircraft headphone receptacles useable with either conventional plugs or with a plug 100 according to the invention. The adapter 152 is of the type allowing a conventional headphone plug to be used with a magnetic receptacle according to the invention. Other adaptations, modifications and improvements will be evident to those of ordinary skill in the art from the illustrations and explanations herein. It is therefore not intended that this invention be limited, except as indicated by the appended claims.

What is claimed is:

1. A signal-carrying receptacle for receiving a complementary plug comprising:
a housing with a first face;
a set of electrical terminals for carrying signals, said terminals being disposed along a circumference on said first face,
a magnet of a first polarity on said first face for engaging a second opposing face in the complementary plug; and
a structure for receiving and aligning the complementary plug with said first face such that electrical contacts of the complementary plug aligns at least axially with said electrical terminals,
wherein said magnet is operative to mate with a specific magnetically attractable element of the complementary plug with sufficient force to maintain reliable electrical connection between said terminals and contacts and not so much force as to result in physical damage upon withdrawal of the plug from said receptacle.

2. The receptacle according to claim 1 wherein said magnet comprises at least one of the electrical terminals, and said magnets are arranged to complement, align and attract said electrical contacts.

3. The receptacle according to claim 1 wherein said aligning and receiving structure comprises at least three magnets mounted on said first face disposed along said circumference, with two of said at least three magnets having a common polarity and being operative to confront magnets arranged in a complementary and opposing polarity pattern on the complementary plug.

4. The receptacle according to claim 3 wherein said magnets are electrical terminals for carrying signals.

5. The receptacle according to claim 1 wherein said aligning and receiving structure is a recess forming a keyway to mate a key shape of the plug for physically orienting the plug to align terminals and contacts.

6. The receptacle according to claim 1 further including a conventional contact phone receptacle, said conventional contact phone receptacle being in said first face.

7. The receptacle according to claim 1 further including a conventional contact phone receptacle, said conventional contact phone receptacle being mounted in the same housing as said terminals and being in electrical contact with said terminals.

8. The receptacle according to claim 7 further including a conventional contact phone plug coupled to the terminals, said conventional contact phone plug being in a position to be inserted into a conventional phone receptacle thereby to define an adapter.

9. The receptacle according to claim 1 further including a conventional contact phone plug coupled to said terminals, said conventional contact phone plug being in a position to be inserted into a conventional phone receptacle thereby to define an adapter.

10. The receptacle according to claim 1 adapted to be mounted in an armrest.

11. A signal-carrying plug for insertion into a complementary signal-carrying receptacle comprising:
a housing with a second face;
electrical contacts for carrying signals, said contacts being disposed along a circumference on said second face,
a magnetically attractable structure on second for mating with a magnet on said first face for engaging a second opposing face in the complementary plug; and
a structure for inserting into and aligning the complementary receptacle with said second face such that electrical contacts of the complementary receptacle align at least axially with said electrical contacts;
wherein said magnetically attractable structure is drawn by the magnet with sufficient force to maintain reliable electrical connection between said contacts and terminals and not so much force as to result in physical damage upon withdrawal of said plug from the magnetic receptacle.

12. The plug according to claim 11 wherein said inserting and aligning structure is a key matched to a recess keyway of a mating shape of the receptacle for physically orienting the plug to align terminals and contacts.

13. The plug according to claim 11 wherein said inserting and aligning structure comprises at least three magnets mounted on said second face disposed along said circumference, with two of said at least three magnets having a common polarity and being operative to confront magnets arranged in a complementary and opposing polarity pattern on the complementary receptacle.

14. The plug according to claim 13 wherein said magnets are electrical contacts for carrying signals.

15. The plug according to claim 11 wherein said magnetically attractable structure is an electrical terminal for carrying signals.

16. The plug according to claim 14 further including a conventional contact phone receptacle, thereby to form an adapter.

17. The plug according to claim 11 further including a conventional contact phone receptacle, thereby to form an adapter.
